(19) United States
(12) Patent Application Publication
(10) Pub. No.: US 2021/0179029 A1
(43) Pub. Date: Jun. 17, 2021

(54) VALVE DEVICE AND CLEANING SYSTEM FOR VEHICLES

(71) Applicant: DENSO CORPORATION, Kariya-city, Aichi-pref. (JP)

(72) Inventors: Yuusuke YAMAUCHI, Kariya-city (JP); Shouta ADACHI, Kariya-city (JP); Takahiro AOYAMA, Kariya-city (JP)

(73) Assignee: DENSO CORPORATION, Kariya-city, Aichi-pref. (JP)

(21) Appl. No.: 17/052,621

(22) PCT Filed: Apr. 9, 2019
(86) PCT No.: PCT/JP2019/015460

§ 371 Date: Nov. 3, 2020

(30) Foreign Application Priority Data
Jun. 28, 2018 (JP) 2018-123275

(51) Int. Cl. B60S 1/48; B60S 1/56; F16K 11/074; F16K 31/524

(52) U.S. Cl. CPC B60S 1/48; F16K 31/52483; F16K 11/074; B60S 1/56

(57) ABSTRACT

A valve device includes a washing inlet, outlets, a switching inlet, a movable switching member, and a conversion engagement portion. The outlets is configured to be in communication with the washing inlet. The movable switching member is movable in a linear direction based on a pressure of a fluid that is fed to the switching inlet. The conversion engagement portion converts linear movement of the movable switching member into a rotation of a predetermined angle. The valve device is configured to switch which of the outlets is in communication with the washing inlet in accordance with a rotation angle of the movable switching member

### CROSS-REFERENCE TO RELATED APPLICATIONS

This application is based upon and claims the benefit of priority from prior Japanese Patent Application No. 2018-123275, filed on Jun. 28, 2018, the entire contents of which are incorporated herein by reference.

### TECHNICAL FIELD

The present disclosure relates to a valve device and a vehicle cleaning system.

### BACKGROUND ART

A recent vehicle may include multiple on-board sensors such as cameras. For each on-board sensor, a cleaning system may include a nozzle. Also, multiple nozzles may be arranged next to one another for a cover glass having a relatively large area.

A valve device may be used to sequentially feed a fluid to such multiple nozzles from a single fluid pump. A valve device may include a rotation switching member that rotates integrally with a worm wheel configured to rotate based on rotation of a rotation shaft of a motor. The valve device may switch outlets so that one of the outlets is in communication with an inlet in accordance with a rotation angle of the rotation switching member (for example, refer to Patent Document 1).

### PRIOR ART DOCUMENT

Patent Document
Patent Document 1: International Patent Publication No. WO2017/085948.

### SUMMARY OF THE INVENTION

In the valve device described above, since the worm wheel configured to rotate based on rotation of the rotational shaft of the motor rotates integrally with a rotary body, for example, advanced control needs to be executed on the motor in order to rotate the rotation switching member by a predetermined angle with high accuracy. Thus, easy and accurate switching of the outlets is difficult.

It is an objective of the present disclosure to provide a valve device and a vehicle cleaning system configured to readily switch outlets with high accuracy.

To achieve the above objective, a valve device includes a washing inlet, outlets, a switching inlet, a movable switching member, and a conversion engagement portion. The outlets are configured to be in communication with the washing inlet. The movable switching member is movable in a linear direction based on a pressure of a fluid that is fed to the switching inlet. The conversion engagement portion is configured to convert linear movement of the movable switching member into a rotation of a predetermined angle. The valve device is configured to switch which of the outlets is in communication with the washing inlet in accordance with a rotation angle of the movable switching member.

In this configuration, the movable switching member is linearly driven based on a pressure of the fluid fed to the switching inlet. The linear movement of the movable switching member is converted into a rotation of the predetermined angle by the conversion engagement portion. Thus, the movable switching member is readily rotated by the predetermined angle. As a result, the outlet that is in communication with the washing inlet is switched in accordance with the rotation angle of the movable switching member. Thus, the outlets are switched with high accuracy by the movable switching member configured to be rotated by the predetermined angle.

To achieve the above objective, a vehicle cleaning system includes the valve device described above, a fluid pump configured to be connected to the switching inlet; and nozzles (13 to 16, 53 to 56) configured to be respectively connected to the outlets.

With this configuration, the advantage described above is obtained in the vehicle cleaning system.

### BRIEF DESCRIPTION OF THE DRAWINGS

The above objectives and other objectives of the present disclosure and aspects and advantages of the present disclosure will become apparent from the following description, taken in conjunction with the accompanying drawings. In the drawings:

FIG. 1 is a schematic diagram of a vehicle on which a vehicle cleaning device is mounted in an embodiment;

FIG. 2 is a schematic diagram showing a configuration of the vehicle cleaning system in the embodiment;

FIG. 3 is a cross-sectional view of a valve device in the embodiment;

FIG. 4 is a perspective view of a case in the embodiment;

FIG. 5 is a plan view showing the case in the embodiment;

FIG. 6 is a perspective view of a first case cover in the embodiment;

FIG. 7 is a bottom view of the first case cover in the embodiment;

FIG. 8 is a perspective view of a movable switching member in the embodiment;

FIG. 9 is a plan view of the movable switching member in the embodiment;

FIG. 10 is a partial cross-sectional perspective view showing an operation of the valve device in the embodiment;

FIG. 11 is a partial cross-sectional perspective view showing an operation of the valve device in the embodiment;

FIG. 12 is a partial cross-sectional perspective view showing an operation of the valve device in the embodiment; and

FIG. 13 is a schematic diagram showing a configuration of a vehicle cleaning system in a further example.

### MODES FOR CARRYING OUT THE INVENTION

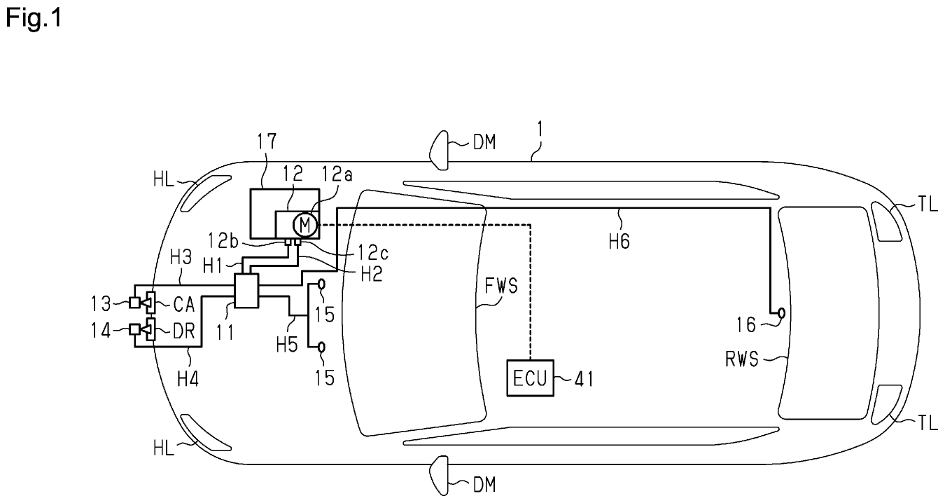

An embodiment of a cleaning system for a vehicle 1 will be described below with reference to FIGS. 1 to 12.

As shown in FIG. 1, the vehicle cleaning system is mounted on the vehicle 1 and includes a valve device 11, a double-outlet pump 12 corresponding to a fluid pump, a tank 17 configured to store a washer liquid, and nozzles 13 to 16. More specifically, the valve device 11, the double-outlet pump 12, and the tank 17 are mounted on a front part of the vehicle 1.

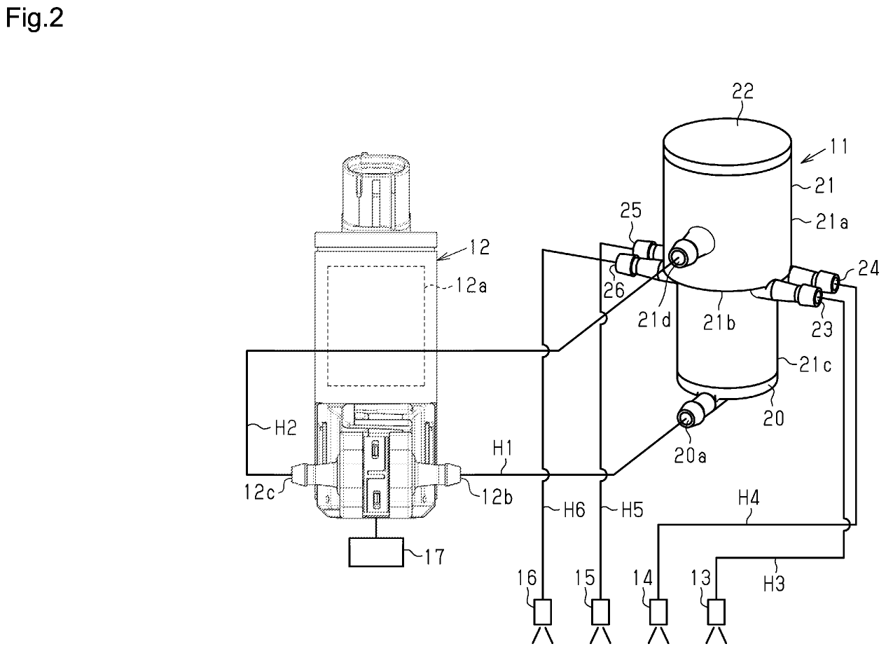

As shown in FIG. 2, the double-outlet pump 12 is a washer pump that includes a motor 12a used as a drive source, a first discharge port 12b, and a second discharge port 12c and is configured to rotate the motor 12a forwardly and reversely so that the washer liquid stored in the tank 17 is discharged selectively from the first discharge port 12b and the second discharge port 12c. As shown in FIG. 1, the nozzles 13 to 16 are, for example, arranged adjacent to respective cleaning subjects such as onboard sensors and include nozzle ports that eject a washer liquid toward the cleaning subjects when the washer liquid is fed. In the present embodiment, the cleaning subjects are an onboard camera CA, a ranging sensor DR (e.g., light detection and ranging or laser imaging detection and ranging (LIDAR)), a front windshield FWS, and a rear windshield RWS. The cleaning subjects include, for example, headlights HL, taillights TL, and mirrors DM in addition to the onboard camera CA, the ranging sensor DR, the front windshield FWS, and the rear windshield RWS.

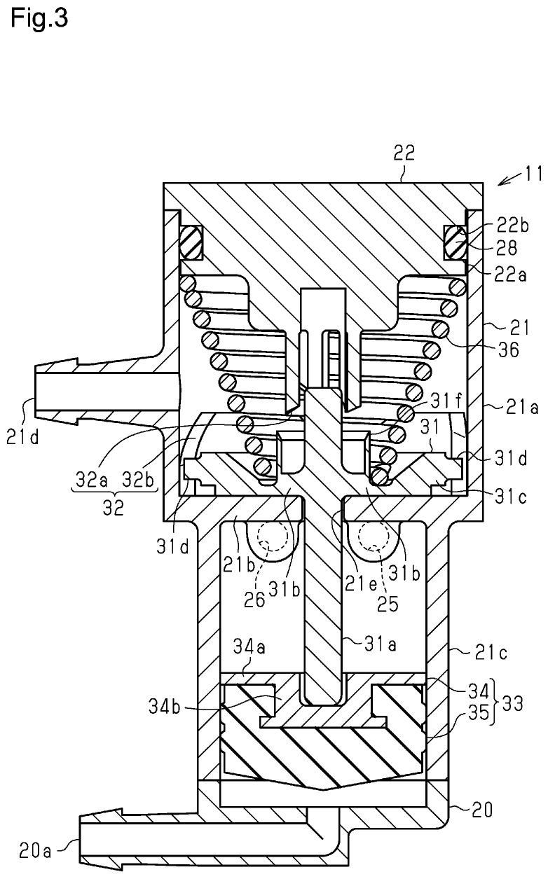

As shown in FIG. 3, the valve device 11 includes a case 21, a first case cover 22, and a second case cover 20.

The case 21 includes a tubular case body 21a substantially having a closed end, which defines a bottom 21b, and a tubular cylinder portion 21c further extending from the bottom 21b of the case body 21a. The cylinder portion 21c has a smaller outer diameter than the case body 21a. The case body 21a and the cylinder portion 21c share the bottom 21b.

As shown in FIGS. 2 to 5, a washing inlet 21d projects outside from a circumferential portion of the case body 21a at an axial center and allows communication between the inside and the outside of the case body 21a.

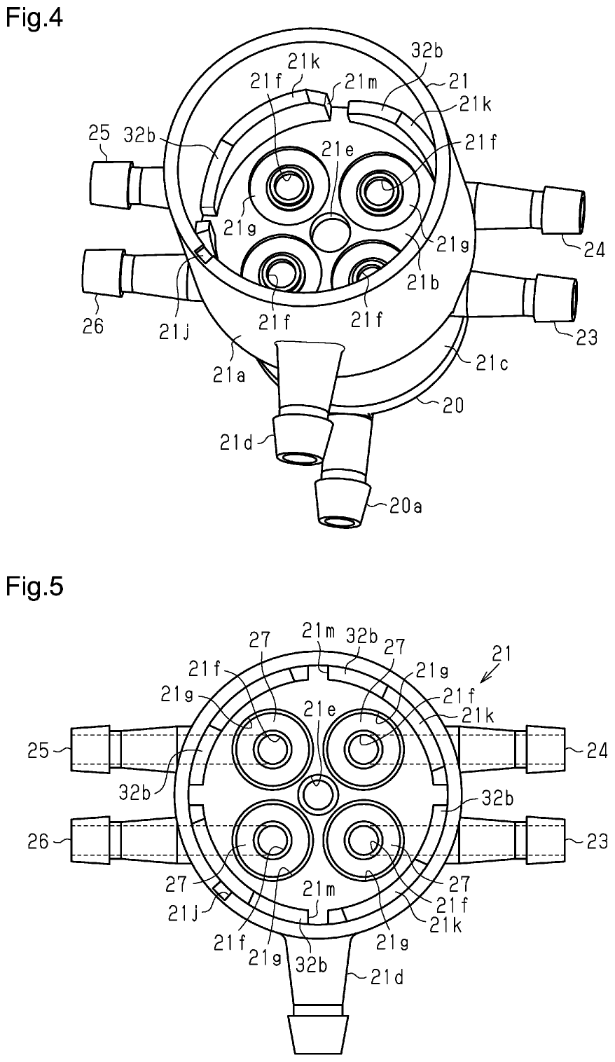

As shown in FIG. 4, the bottom 21b of the case body 21a includes a central hole 21e and four communication holes 21f arranged around the central hole 21e at equiangular (90°) intervals in the circumferential direction. Four outlets 23 to 26 are arranged on the bottom 21b of the case body 21a. The outlets 23 to 26 are in communication with the inside of the case body 21a via the communication holes 21f and project from the inside of the cylinder portion 21c to the exterior.

As shown in FIG. 5, annular recesses 21g are respectively formed around the communication holes 21f in the bottom 21b of the case body 21a so as to extend around the communication holes 21f. The annular recesses 21g retain annular rubber seals 27.

As shown in FIGS. 2 and 3, the tubular second case cover 20 substantially having a closed end is adhered to an open end (end located at a side opposite to the case body 21a) of the cylinder portion 21c. More specifically, the open end of the cylinder portion 21c is welded to the second case cover 20. A switching inlet 20a projects from the bottom of the second case cover 20 to the exterior and allows communication between the inside and the outside of the cylinder portion 21c. In the present embodiment, the washing inlet 21d and the switching inlet 20a project radially outward from the case 21 in the same direction (in FIG. 5, lower direction). In the present embodiment, pairs of the four outlets 23 to 26 project parallel to each other and away from each other in a direction (sideward direction in FIG. 5) orthogonal to the direction in which the washing inlet 21d and the switching inlet 20a project.

The first case cover 22 is fixed to an open end of the case body 21a.

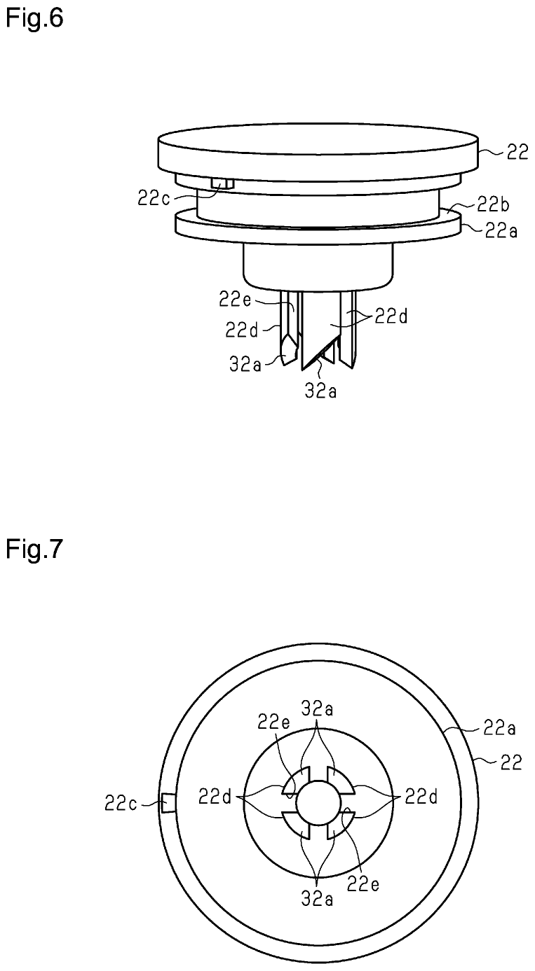

As shown in FIGS. 6 and 7, an inner extension 22a axially extends from an end surface of the first case cover 22 opposed to the case body 21a, and an annular groove 22b is formed in an outer circumference of the inner extension 22a. As shown in FIG. 3, an annular rubber seal 28 is fitted to the annular groove 22b and is in tight contact with an inner circumferential surface of the case body 21a to hermetically seal the case body 21a. As shown in FIGS. 4 and 5, a recess 21j is formed in a circumferential portion of the open end of the case body 21a. As shown in FIGS. 6 and 7, the first case cover 22 includes a projection 22c fitted to the recess 21j. The fitting of the projection 22c to the recess 21j circumferentially positions the first case cover 22 in relation to the case body 21a and stops circumferential movement of the first case cover 22. In an example, the case body 21a and the first case cover 22 are fixed to each other by welding.

As shown in FIG. 3, the valve device 11 includes a movable switching member 31 and a conversion engagement portion 32. The movable switching member 31 is movable in a linear direction (in FIG. 3, vertical direction) based on a pressure of the washer liquid, which corresponds to a fluid that is fed to the switching inlet 20a. The conversion engagement portion 32 converts linear movement of the movable switching member 31 into a rotation of a predetermined angle. The rotation refers to a rotation of the movable switching member 31 about an axis extending in the linear direction.

More specifically, as shown in FIG. 3, a piston member 33 is arranged in the cylinder portion 21c and is movable in the linear direction based on a pressure of the washer liquid, which corresponds to the fluid fed to the switching inlet 20a. The piston member 33 includes a base member 34 and a rubber member 35. The base member 34 includes a discoid base disc 34a and a tube 34b having a closed end and projecting from a center of the base disc 34a. The rubber member 35 is fitted onto the tube 34b and configured to slide on an inner circumferential surface of the cylinder portion 21c. Thus, the piston member 33 is movable in the linear direction based on a pressure of the washer liquid that is fed to the cylinder portion 21c through the switching inlet 20a.

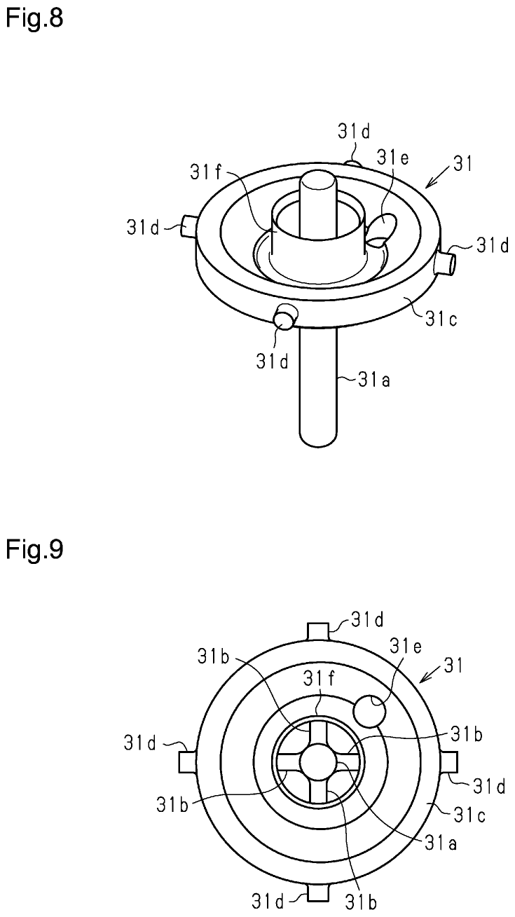

As shown in FIGS. 8 and 9, the movable switching member 31 includes a rod-shaped shaft 31a, inner engaged portions 31b projecting radially outward from circumferential portions of the shaft 31a, a discoid disc 31c connecting distal ends of the inner engaged portions 31b to each other, and outer engaged portions 31d projecting radially outward from circumferential portions of the disc 31c. In the present embodiment, four inner engaged portions 31b and four outer engaged portions 31d are arranged at equiangular (90°) intervals in the circumferential direction. In the present embodiment, each of the inner engaged portions 31b and each of the outer engaged portions 31d are arranged in the same direction with the shaft 31a serving as an axis. In the present embodiment, the inner engaged portions 31b and the outer engaged portions 31d form engaged portions. In addition, a switching hole 31e axially extends through the disc 31c of the movable switching member 31 and partially extends in the circumferential direction. In the present embodiment, the disc 31c of the movable switching member 31 has an inner edge from which a thin tube 31f extends in the axial direction.

As shown in FIG. 3, the movable switching member 31 is arranged so that the disc 31c is movable in the case body 21a in the axial direction (linear direction). The shaft 31a includes a first portion located toward the first case cover 22 from a portion on which the inner engaged portions 31b are arranged and a second portion located toward the second case cover 20 from the portion on which the inner engaged portions 31b are arranged. The second portion of the shaft 31a is longer than the first portion of the shaft 31a. The second portion of the shaft 31a extends through the central hole 21e and is located in the cylinder portion 21c, so that the distal end of the second portion is in contact with the bottom of the tube 34b in the base member 34 of the piston member 33. In the present embodiment, the distal end of the second portion of the shaft 31a is in contact with the bottom of the tube 34b. However, there is no limitation to such a configuration. For example, the distal end of the second portion of the shaft 31a may be press-fitted to the tube 34b.

The valve device 11 further includes a coil spring 36 corresponding to a biasing member arranged in a compressed state between the inner extension 22a of the first case cover 22 and the disc 31c of the movable switching member 31. The coil spring 36 constantly biases the disc 31c of the movable switching member 31 toward the bottom 21b of the case body 21a. In the present embodiment, the outer diameter of the coil spring 36 at one end (in FIG. 3, upper end) is set to be substantially the same as the inner diameter of the case body 21a, and the inner diameter of the coil spring 36 at the other end (in FIG. 3, lower end) is set to be substantially the same as the outer diameter of the tube 31f. The coil spring 36 is a conical coil spring, the diameter of which gradually decreases from one end to the other end.

When the disc 31c is in contact with the bottom 21b of the case body 21a, the switching hole 31e is allowed to be in communication with one of the communication holes 21f, and the outlet that is in communication with the washing inlet 21d is switched between the outlets 23 to 26 in accordance with a rotation angle of the movable switching member 31. When the disc 31c is in contact with the bottom 21b of the case body 21a, the rubber seals 27 are compressed and are in tight contact with the disc 31c. This prevents leakage of the washer liquid, which corresponds to the fluid, to ones of the communication holes 21f that are not aligned with the switching hole 31e in the circumferential direction.

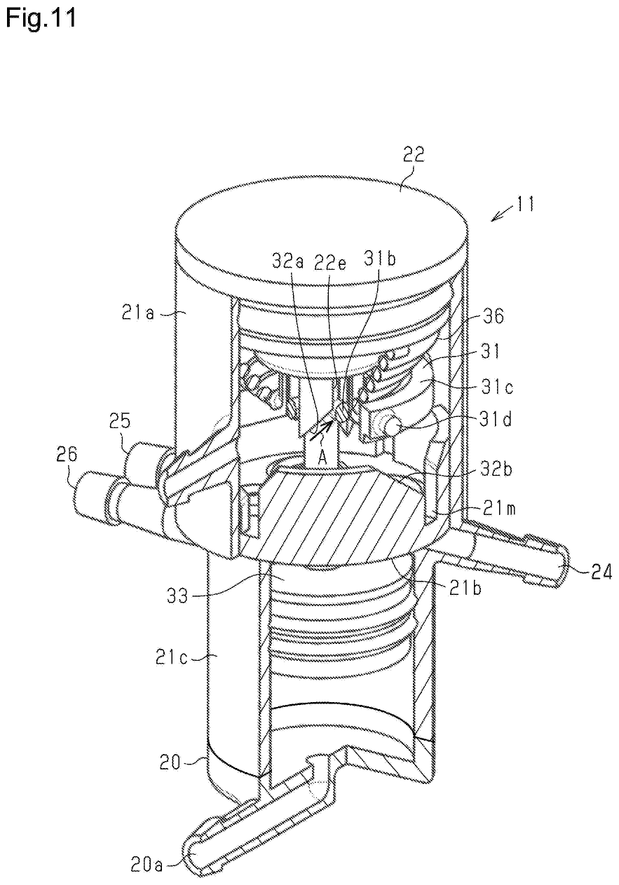

The conversion engagement portion 32 includes first inclined surfaces 32a that come into contact with the inner engaged portions 31b and guide the movable switching member 31 including the inner engaged portions 31b toward one side in the circumferential direction (in FIG. 11, counterclockwise about the shaft 31a) as the movable switching member 31 moves toward one side (in FIG. 3, upward) in the linear direction. The conversion engagement portion 32 also includes second inclined surfaces 32b that come into contact with the outer engaged portions 31d and guide the movable switching member 31 including the outer engaged portions 31d toward the one side in the circumferential direction as the movable switching member 31 moves toward the other side (in FIG. 3, downward) in the linear direction.

More specifically, as shown in FIGS. 6 and 7, engagement pieces 22d are arranged on the inner extension 22a of the first case cover 22 at positions radially corresponding to the inner engaged portions 31b and extend further axially downward (toward the cylinder portion 21c). Four engagement pieces 22d are arranged at equiangular (90°) intervals in the circumferential direction. Each engagement piece 22d has a distal end including the first inclined surface 32a that is lowered toward one side in the circumferential direction. A gap between the engagement pieces 22d in the circumferential direction has the same width as the circumferential width of each inner engaged portion 31b and defines an inner retaining groove 22e allowing for the fitting of the inner engaged portion 31b.

In addition, engagement protrusions 21k are arranged on the bottom 21b of the case body 21a at positions continuous with the inner circumferential surface of the case body 21a and radially corresponding to the outer engaged portions 31d. The engagement protrusions 21k extend axially upward (toward the opening of the case body 21a). Four engagement protrusions 21k are arranged at equiangular (90°) intervals in the circumferential direction. Each engagement protrusion 21k has a distal end including the second inclined surface 32b that is lowered toward one side in the circumferential direction. A gap between the engagement protrusions 21k in the circumferential direction has the same width as the circumferential width of each outer engaged portion 31d and defines an outer retaining groove 21m allowing for the fitting of the outer engaged portion 31d. When the outer engaged portions 31d are fitted to the outer retaining grooves 21m, the circumferential position of the switching hole 31e in the movable switching member 31 conforms to the circumferential position of one of the communication holes 21f, so that the washing inlet 21d is in communication with only one of the outlets 23 to 26.

As shown in FIG. 2, the first discharge port 12b of the double-outlet pump 12 is connected to the switching inlet 20a by a hose H1, and the second discharge port 12c is connected to the washing inlet 21d by a hose H2. The outlets 23 to 26 are respectively connected to the nozzles 13 to 16 by hoses H3 to H6.

The operation of the vehicle cleaning system configured as described above will now be described.

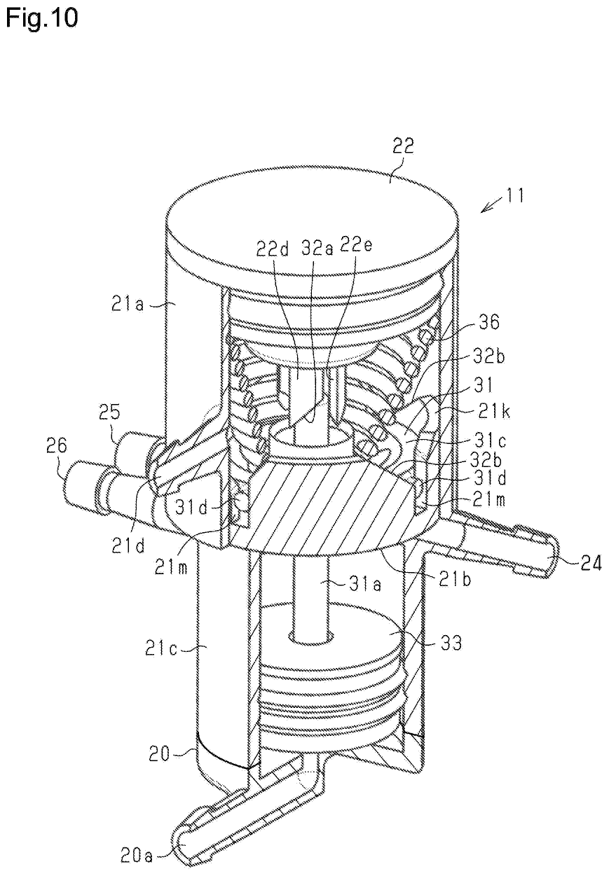

As shown in FIG. 10, when the washer liquid is not fed to the switching inlet 20a, the disc 31c of the movable switching member 31 is in contact with (more specifically, pushed and in contact with) the bottom 21b of the case body 21a by the biasing force of the coil spring 36. In this state, the outer engaged portions 31d are fitted to the outer retaining grooves 21m.

For example, when a cleaning switch, which is arranged at the driver seat and is not shown in the drawings, is operated, and the motor 12a of the double-outlet pump 12 is rotated forward, the washer liquid stored in the tank 17 is discharged from the first discharge port 12b. As a result, the movable switching member 31 is driven together with the piston member 33 toward one side (in FIG. 3, upward) in the linear direction against the biasing force of the coil spring 36 based on the pressure of the washer liquid fed to the switching inlet 20a. That is, the movable switching member 31 is linearly moved in accordance with linear movement of the piston member 33.

At this time, as indicated by arrow A in FIG. 11, the inner engaged portions 31b come into contact with (slide on) the first inclined surfaces 32a, and the movable switching member 31 including the inner engaged portions 31b is guided toward one side in the circumferential direction and rotated to a position where the inner engaged portions 31b are fitted to the inner retaining grooves 22e. When the double-outlet pump 12 is stopped, the disc 31c of the movable switching member 31 is actuated by the biasing force of the coil spring 36 toward the other side (in FIG. 3, downward) in the linear direction.

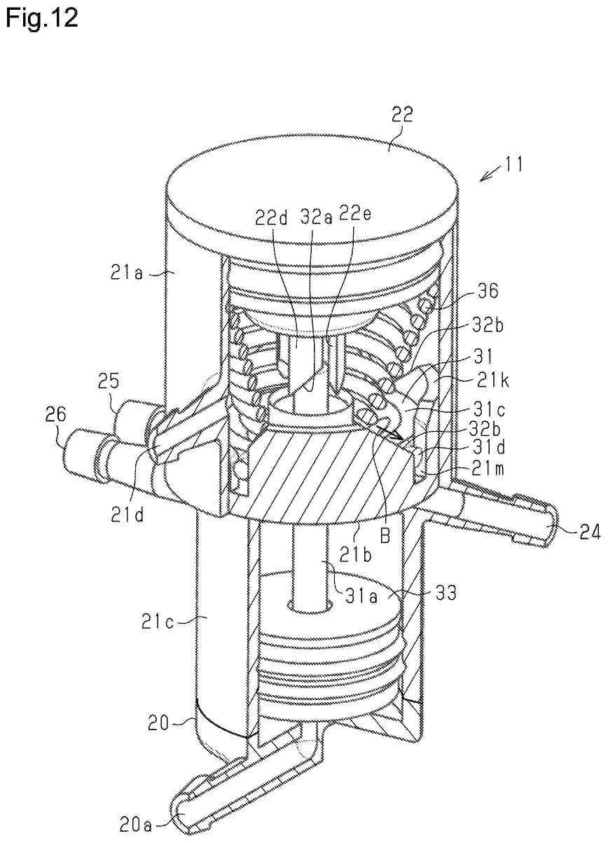

At this time, as indicated by arrow B in FIG. 12, the outer engaged portions 31d come into contact with (slide on) the second inclined surfaces 32b, and the movable switching member 31 including the outer engaged portions 31d is guided toward the one side in the circumferential direction and rotated to a position where the outer engaged portions 31d are fitted to the outer retaining grooves 21m. As a result, the switching hole 31e is rotated together with the movable switching member 31 by 90°, that is, a predetermined angle, so that the outlet that is in communication with the washing inlet 21d is switched between the outlets 23 to 26.

Then, when the motor 12a of the double-outlet pump 12 is rotated reversely, the washer liquid stored in the tank 17 is discharged from the second discharge port 12c. As a result, the washer liquid fed from the washing inlet 21d to the case body 21a is discharged from the one of the outlets 23 to 26 in communication with the switching hole 31e and is ejected toward the cleaning subject from the one of the nozzles 13 to 16 connected by the one of the hoses H3 to H6 corresponding to the one of the outlets 23 to 26. For example, when the switching hole 31e is in communication with the outlet 23, the washer liquid supplied from the washing inlet 21d to the case body 21a is ejected toward the onboard camera CA from the nozzle 13 through the switching hole 31e, the outlet 23, and the hose H3.

As described above, the operation in which the motor 12a of the double-outlet pump 12 is rotated forward to switch which of the outlets 23 to 26 is in communication with the washing inlet 21d and the motor 12a of the double-outlet pump 12 is rotated reversely to eject the washer liquid from one of the nozzles 13 to 16 is repeated so that the washer liquid is ejected sequentially from the nozzles 13 to 16.

An ECU 41 (refer to FIG. 1) is connected to the motor 12a of the double-outlet pump 12 and stores the number of times the motor 12a is rotated forward (the number of instructions to rotate the motor 12a forward) so that the ECU 41 recognizes which one of the outlets 23 to 26 is in communication with the switching hole 31e and connects the switching hole 31e to the desired one of the outlets 23 to 26 in accordance with an instruction signal from the cleaning switch or a sensor.

The advantages of the embodiment will be described below.

(1) The movable switching member 31 is driven in the linear direction based on a pressure of the washer liquid, which corresponds to the fluid fed to the switching inlet 20a. The linear movement of the movable switching member 31 is converted into a rotation of the predetermined angle by the conversion engagement portion 32 (the first inclined surfaces 32a and the second inclined surfaces 32b). Thus, the movable switching member 31 is readily rotated by the predetermined angle. The outlet that is in communication with the washing inlet 21d is switched between the outlets 23 to 26 in accordance with the rotation angle of the movable switching member 31. Thus, the outlets 23 to 26 are switched with high accuracy using the movable switching member 31 configured to be rotated by the predetermined angle.

(2) The movable switching member 31 is actuated toward one side in the linear direction by the pressure of the washer liquid, which corresponds to the fluid fed to the switching inlet 20a, and is actuated toward the other side in the linear direction by the biasing force of the coil spring 36, which corresponds to the biasing member. In this configuration, the fluid pump connected to the switching inlet 20a may be configured to apply the pressure of the washer liquid in only one direction. For example, as in the present embodiment, a fluid pump configured to only apply pressure (in the present embodiment, the double-outlet pump 12) may be used.

(3) As the movable switching member 31 is moved toward one side in the linear direction, the inner engaged portions 31b of the movable switching member 31 come into contact with the first inclined surfaces 32a, and the movable switching member 31 including the inner engaged portions 31b is guided toward one side in the circumferential direction. As the movable switching member 31 is moved toward the other side in the linear direction, the outer engaged portions 31d come into contact with the second inclined surface 32b, and the movable switching member 31 including the outer engaged portions 31d is guided toward the one side in the circumferential direction. Thus, when the movable switching member 31 is driven forward and backward once in the linear direction, the movable switching member 31 is rotated by the predetermined angle (in the present embodiment, 90°) in the circumferential direction along the first inclined surfaces 32a and the second inclined surfaces 32b.

(4) The first inclined surface 32a is arranged at an inner side of the inner circumferential surface of the case 21 (more specifically, the case body 21a) and spaced apart from the inner circumferential surface of the case 21. This allows the first inclined surface 32a to have a steep slope while shorting the first inclined surface 32a in the linear direction. More specifically, when a first inclined surface is arranged on the inner circumferential surface of the case 21 (more specifically, the case body 21a) and is continuous with the inner circumferential surface of the case 21, the first inclined surface is located at the radially outermost side of the case 21. This increases the circumferential length for guiding in relation to the circumferential angle for guiding. To obtain a steep slope so that the engaged portion is smoothly guided, the length needs to be increased in the linear direction. In contrast, when a first inclined surface is arranged at an inner side of the inner circumferential surface of the case 21 and spaced apart from the inner circumferential surface of the case 21, the circumferential length for guiding is decreased in relation to the circumferential angle for guiding. Thus, while the first inclined surface 32a has a steep slope allowing for the smooth guide of the engaged portion (i.e., the inner engaged portion 31b), the first inclined surface 32a may be shortened in the linear direction. Accordingly, the movable switching member 31 is appropriately guided in the circumferential direction in the valve device 11 that is shortened in the linear direction.

(5) The double-outlet pump 12 is configured to discharge the washer liquid selectively from the first discharge port 12b and the second discharge port 12c in accordance with forward and reverse rotations of the motor 12a. The first discharge port 12b is connected to the switching inlet 20a. The second discharge port 12c is connected to the washing inlet 21d. The washer liquid is ejected sequentially from the nozzles 13 to 16 by operation of the single double-outlet pump 12.

(6) The inner engaged portions 31b are configured to fit to the inner retaining grooves 22e, so that the movable switching member 31 is rotated by the predetermined angle in the circumferential direction. Also, the outer engaged portions 31d are configured to fit to the outer retaining grooves 21m, so that the movable switching member 31 is rotated by the predetermined angle in the circumferential direction. In addition, when an external force is applied, rotation of the movable switching member 31 in the circumferential direction is prevented.

The present embodiment may be modified as follows. The present embodiment and the following modified examples can be combined as long as the combined modified examples remain technically consistent with each other.

In the above embodiment, the valve device 11 is configured to change the passage of the washer liquid as the fluid. Instead, a valve device may change the passage of air as the fluid.

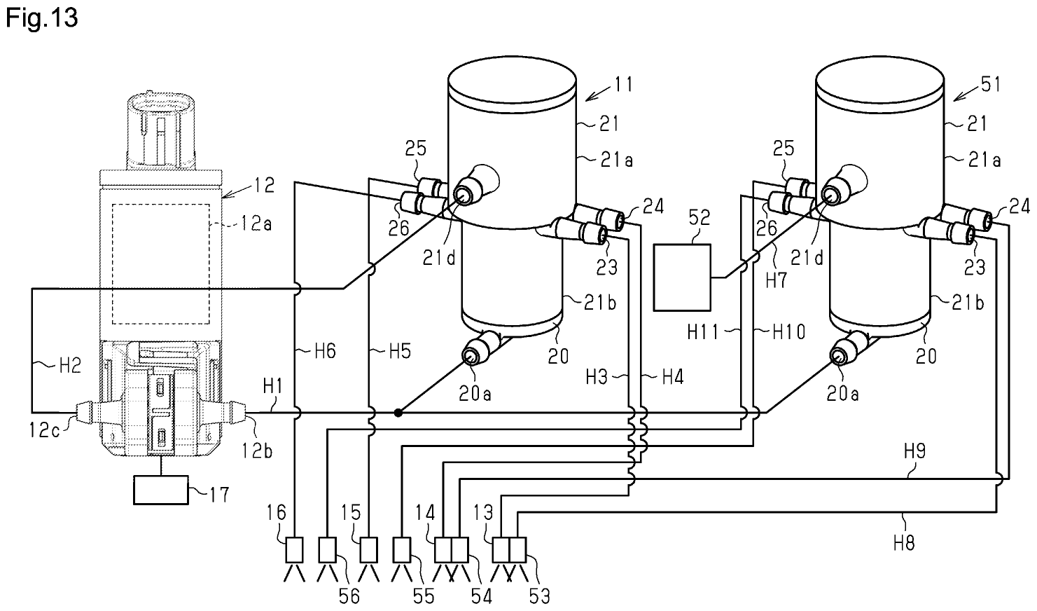

More specifically, for example, a valve device may be embodied in a vehicle cleaning system shown in FIG. 13. In this example, the vehicle cleaning system includes a valve device 51 having the same configuration as the valve device 11 of the embodiment and changing the passage of air, an air pump 52, and air nozzles 53 to 56 ejecting air toward the cleaning subjects when the air is fed, in addition to the vehicle cleaning system including the washer liquid valve device 11 of the above embodiment. The air nozzles 53 and 54 are arranged adjacent to the washer liquid nozzles 13 and 14 of the above embodiment to eject air to the same cleaning subjects as the nozzles 13 and 14. The air nozzles 55 and 56 eject air toward cleaning subjects (e.g., the mirrors DM or a ranging sensor located at a side surface of the vehicle 1) that differ from the cleaning subjects (the front windshield FWS and the rear windshield RWS) of the nozzles 15 and 16.

The first discharge port 12b of the double-outlet pump 12 is connected by the hose H1 to the switching inlet 20a of the air valve device 51 in addition to the switching inlet 20a of the washer liquid valve device 11 of the above embodiment. The air pump 52 is connected to the washing inlet 21d of the air valve device 51 by a hose H7. The outlets 23 to 26 of the air valve device 51 are respectively connected to the air nozzles 53 to 56 by hoses H8 to H11.

In this configuration, besides the advantages of the above embodiment, the outlet that is in communication with the washing inlet 21d of the air valve device 51 is switched between the outlets 23 to 26 in synchronization with the washer liquid valve device 11. Also, there is no need to add a separate drive source for switching the outlets 23 to 26 of the air valve device 51. The washer liquid and the air may be simultaneously or sequentially ejected toward the cleaning subjects, so that the cleaning subjects are appropriately cleaned.

The fluid pump connected to the washer liquid valve device 11 and the switching inlet 20a of the air valve device 51 to feed the fluids may differ from the double-outlet pump 12. For example, a single-outlet pump may be used to feed a fluid (liquid or air) to only the switching inlet 20a.

In the above embodiment, the coil spring 36 is included as the biasing member. Instead, a fluid pump configured to depressurize (apply negative pressure to) the fluid fed to the switching inlet 20a may be used to move the movable switching member 31 toward the other side in the linear direction with the depressurization (negative pressure) without including a biasing member.

In the above embodiment, the first inclined surface 32a is arranged at an inner side of the inner circumferential surface of the case 21 (more specifically, the case body 21a) and spaced apart from the inner circumferential surface of the case 21. Instead, a first inclined surface may be arranged continuously with the inner circumferential surface of the case body 21a. Moreover, the second inclined surface 32b may be arranged at an inner side of the inner circumferential surface of the case body 21a and spaced apart from the inner circumferential surface of the case body 21a. In the above embodiment, the engaged portions include the inner engaged portions 31b and the outer engaged portions 31d. However, the engaged portions may include only one of the inner engaged portions 31b and the outer engaged portions 31d, if appropriate.

The above embodiment includes four outlets 23 to 26. However, the number of outlets may be changed and may be, for example, three or six. In this case, the number of communication holes 21f may be changed in correspondence with the number of outlets. Also, the angle by which the switching hole 31e is rotated when the movable switching member 31 is driven forward and backward once in the linear direction, may be changed in accordance with the number of communication holes 21f.

In the above embodiment, the washing inlet 21d is constantly in communication with one of the outlets 23 to 26. Instead, the washing inlet 21d may be in communication with two or more of the outlets 23 to 26.

In the above embodiment, when the disc 31c is in contact with the bottom 21b of the case body 21a, the switching hole 31e is in communication with one of the communication holes 21f. However, there is no limitation to such a configuration. For example, the switching hole 31e may be configured not to be in communication with any of the communication holes 21f when the disc 31c is in contact with the bottom 21b of the case body 21a.

The present disclosure is described in accordance with exemplified examples but is not limited to the exemplified examples and its structure. The present disclosure embraces various modified examples and variations within the scope of equivalents. In addition, various combinations and forms, and other combinations and forms including only one element or more or less than one element are also within the scope and spirit of the present disclosure.

1. A valve device, comprising:
a washing inlet;
outlets configured to be in communication with the washing inlet;
a switching inlet;
a movable switching member movable in a linear direction based on a pressure of a fluid that is fed to the switching inlet; and
a conversion engagement portion configured to convert linear movement of the movable switching member into a rotation of a predetermined angle,
wherein the valve device is configured to switch which of the outlets is in communication with the washing inlet in accordance with a rotation angle of the movable switching member.

2. The valve device according to claim 1, further comprising: a biasing member configured to bias the movable switching member, wherein
the movable switching member is configured to be biased and actuated toward one side in the linear direction by the pressure of the fluid fed to the switching inlet, and
the movable switching member is configured to be biased and actuated toward the other side in the linear direction by a biasing force of the biasing member.

3. The valve device according to claim 1, wherein
the valve device includes a case on which the washing inlet, the outlets, and the switching inlet are arranged, and
the movable switching member and the conversion engagement portion are accommodated in the case.

4. The valve device according to claim 3, wherein
the case includes a cylinder portion and a case body,
the cylinder portion is in communication with the switching inlet and accommodates a piston member configured to be moved in the linear direction by a pressure of a fluid fed from the switching inlet, and
the case body accommodates the movable switching member and the conversion engagement portion and is in communication with the washing inlet and the outlets.

5. The valve device according to claim 4, wherein the movable switching member is configured to be moved in the linear direction in accordance with movement of the piston member in the linear direction.

6. The valve device according to claim 4, wherein
the piston member includes a base member and a rubber member, and
the rubber member is arranged to slide on an inner circumferential surface of the cylinder portion.

7. The valve device according to claim 4, wherein
the cylinder portion includes a case cover arranged on an end of the cylinder portion located at a side opposite to the case body, and
the case cover has a bottom on which the switching inlet is arranged.

8. The valve device according to claim 7, wherein the washing inlet and the switching inlet project radially outward from the case in the same direction.

9. The valve device according to claim 3, wherein
the movable switching member includes engaged portions arranged partially around a circumference of the movable switching member,
the conversion engagement portion includes a first inclined surface and a second inclined surface,
the first inclined surface is configured to come into contact with one of the engaged portions and guide the movable switching portion including the one engaged portion toward one side in a circumferential direction as the movable switching member moves toward one side in the linear direction, and
the second inclined surface is configured to come into contact with the other one of the engaged portions and guide the movable switching member including the other engaged portion toward the one side in the circumferential direction as the movable switching member moves toward the other side in the linear direction.

10. The valve device according to claim 9, wherein at least one of the first inclined surface or the second inclined surface is arranged at an inner side of an inner circumferential surface of the case and spaced apart from the inner circumferential surface of the case.

11. A vehicle cleaning system, comprising:
the valve device according to claim 1;
a fluid pump configured to be connected to the switching inlet; and
nozzles configured to be respectively connected to the outlets.

12. The vehicle cleaning system according to claim 11, wherein
the fluid pump includes a double-outlet pump configured to discharge a fluid selectively from a first discharge port and a second discharge port in accordance with forward and reverse rotations of a drive source,
the first discharge port is connected to the switching inlet, and
the second discharge port is connected to the washing inlet.

13. The vehicle cleaning system according to claim 11, wherein
the fluid pump includes a washer pump configured to supply a washer liquid,
the valve device includes a washing valve device, and
the vehicle cleaning system further comprises:
an air valve device; and
an air pump configured to be connected to a washing inlet of the air valve device.

14. The vehicle cleaning system according to claim 13, wherein
the fluid pump includes a double-outlet pump configured to discharge the washer liquid selectively from a first discharge port and a second discharge port in accordance with forward and reverse rotations of a drive source,
the first discharge port of the double-outlet pump is configured to be connected to the switching inlet of the washing valve device and a switching inlet of the air valve device, and
the second discharge port of the double-outlet pump is configured to be connected to the washing inlet of the washing valve device.
